(19) United States
(12) Patent Application Publication
(10) Pub. No.: US 2006/0268137 A1
(43) Pub. Date: Nov. 30, 2006

(54) System and method for reducing read-out noise in a pixel array

(76) Inventor: Charles Grant Myers, Corvallis, OR (US)

Correspondence Address: AVAGO TECHNOLOGIES, LTD., P.O. BOX 1920, DENVER, CO, 80201-1920, US

(21) Appl. No.: 11/142,166

(22) Filed: May 31, 2005

(51) Int. Cl. H04N 5/335

(52) U.S. Cl. 348/294

(57) ABSTRACT

A system and method utilizing an imaging device able to distribute readout paths for pixel signals in a captured image. The device includes a pixel array organized into a plurality of sets of pixels, each pixel in each set of pixels operable to store a signal corresponding to a respective light level. The device further includes a readout circuit having a plurality of readout paths coupled to the pixel array, each readout path operable to read the signal stored in a corresponding pixel in a set of pixels, each readout path corresponding to one pixel during a readout phase for each set of pixels. The device further includes a readout path selection circuit coupled to the readout circuit and operable set a pattern for matching one readout path to one pixel for each set of pixels for each readout phase, the pattern differing from set to set.

### BACKGROUND OF THE INVENTION

Digital cameras and digital imaging devices typically use pixel arrays, such as CMOS arrays (complimentary metal-oxide semiconductor) or CCD arrays (charge-couple device), for capturing light in a pixel-by-pixel manner to form digital images. When light strikes a typical pixel, a light-sensitive device, such as a photodiode, is charged to a level corresponding to the amount of light incident upon the pixel. Once a charge is stored on the light-sensing device, the charge may then be used to generate an electrical pulse that is representative of the corresponding light level. This electrical pulse, typically expressed as a voltage, may be manipulated and stored according to known analog and digital processing methods. One such known method may be described with respect to the conventional imaging system of FIG. 1.

FIG. 1 shows a portion of a conventional imaging system 100 for collecting and storing incident light as an image. The system includes a pixel array 140 that, for the purposes of this example, may be a CMOS array. The pixel array 140 is typically organized into rows 151a-151n and columns 161a-161n such that row control circuitry 150 may be used to manipulate the pixels on a row-by-row basis and column readout circuitry 160 may be used to sample the pixels in a column-by-column basis.

During a typical “readout” phase of an image capturing method, each pixel's corresponding voltage signal may be read and stored. The row control circuitry 150 enables a first row 151a such that the stored charge may be translated into a voltage signal that propagates through the column readout circuitry 160, via readout circuits 162a-162n that correspond to each column 161a-161n. That is, during the first row 151a readout phase, a voltage signal generated from the pixel in the first column 161a is read out through the first read-out circuit 162a, the pixel in the second column 161b is readout through the second readout circuit 162b, the pixel in the third column is readout through the third readout circuit 162c, and so on.

In this manner, each pixel in a given row 151a-151n may be readout through the column readout circuitry 160 simultaneously. The process repeats for the next row 151b and the next 151c until all rows have been readout. The readout circuits 162a-162n of the column readout circuitry 160 are typically coupled to a multiplexer (not shown) such that the data collected from the pixels may be sampled and stored in a memory (also not shown). The data collected may then be reconstructed to form an image that represents the light that was captured by each pixel.

Problems may arise, however, when reading each pixel in each columns of pixels 161a-161n through dedicated respective readout circuit 162a-162n. Readout circuits 162a-162n typically comprise solid state devices, such as MOSFET transistors and the like, which are subject to manufacturing variables, performance variables, and other phenomena collectively referred to as “errors.” Errors may be so problematic in any given device that the purpose for which the device is manufactured cannot be realized. However, most errors are slight and often not cost-efficient to remedy and/or eliminate during a manufacturing process. Thus, in most electronics, tolerances and error ranges are provided, expected, worked-around, and/or generally engineered out of the resultant system. To avoid extremely expensive tolerancing in manufacturing readout circuits 162a-162n for a pixel array 140 (typically all on one integrated circuit), manufacturing with errors is typically expected but may be a significant source of noise as is shown below in FIG. 2.

FIG. 2 shows a digital picture 200 constructed from data collected by the conventional imaging system 100 of FIG. 1 having one column readout circuit with a significant error. Typically, errors that may occur in the pixels themselves are not very problematic. For example, in a pixel array with millions of pixels, it is very difficult for the human eye to discern a handful of “bad pixels” in a picture reconstructed from data collected by the pixel array. However, when errors arise in one or more readout circuits 162a-162n, noise that is introduced because of the error is repeated for every voltage signal corresponding to each pixel in every row that propagates through the error-prone readout circuit. Thus, if one particular readout circuit has an error that causes noise to be introduced, then the resulting noise in the image, in fact, does become discernable to the human eye. Furthermore, in low-light situations that require higher amplification of the signals representing the captured light, errors in one or more readout circuits are exacerbated all the more.

As can be seen in FIG. 2, the digital image 200 shows noise resulting from an error in a single column repeated for every single row resulting in very undesirable dark line 210 (exaggerated for illustrative purposes). Thus, even a single error in a single readout circuit may have a noticeable effect on the resultant image collected by the imaging system 100.

Typically, errors that may cause these types of problems include column mismatch errors, device sizes being different due to manufacturing variation, offset in the MOSFET threshold voltage range, and the like. These types of errors are often times difficult to completely eliminate in the manufacturing process. Thus, even if one error occurs in the column readout circuitry 160, it may render an entire IC unusable because of repeating nature of the data collection through the readout circuits 162a-162n.

### SUMMARY OF THE INVENTION

An embodiment of the invention is directed to a system and method utilizing an imaging device comprising for distributing the readout path for pixel signals in a captured image. The device includes a pixel array organized into a plurality of sets of pixels, each pixel in each set of pixels operable to store a signal corresponding to a respective light level. The device further includes a readout circuit having a plurality of readout paths coupled to the pixel array, each readout path operable to read the signal stored in a corresponding pixel in a set of pixels, each readout path corresponding to one pixel during a readout phase for each set of pixels. The device further includes a readout path selection circuit coupled to the readout circuit and operable set a pattern for matching one readout path to one pixel for each set of pixels for each readout phase, the pattern differing from set to set.

By utilizing a readout path distribution system within an image capturing device, any particular readout circuit that may have an error such that noise is introduced to any signal propagating through the error-prone readout circuit, the resulting effect on any reconstructed and stored images is reduced. The noise will be spread out across several image columns instead of aligning all in one as with conventional imaging systems. As a result, the distributed noise is less discernable to the human eye because the pixel signals that are affected by the error-prone readout circuit correspond to different columns because of a random a patterned readout path for each row.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a portion of a conventional imaging system for collecting and storing incident light as a digital image;

FIG. 2 shows a digital picture constructed from data collected by the conventional imaging system of FIG. 1 having one column readout circuit with a significant error;

FIG. 3 shows a portion of an imaging system 300 for collecting and storing incident light using a pixel array according to an embodiment of the invention;

FIG. 4 shows a digital picture constructed form data collected by the imaging system of FIG. 3 having a distributed readout path over four columns associated with a readout circuit with a significant error according to an embodiment of the invention; and

FIG. 5 shows a block diagram of an imaging system that includes the imaging device of FIG. 3 according to an embodiment of the invention.

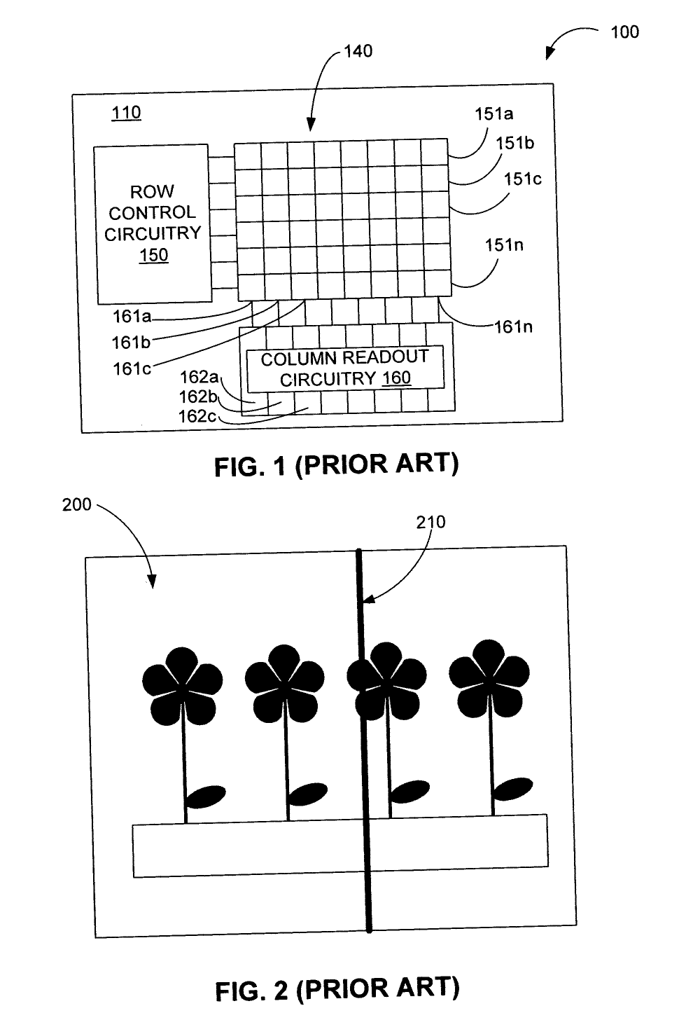

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

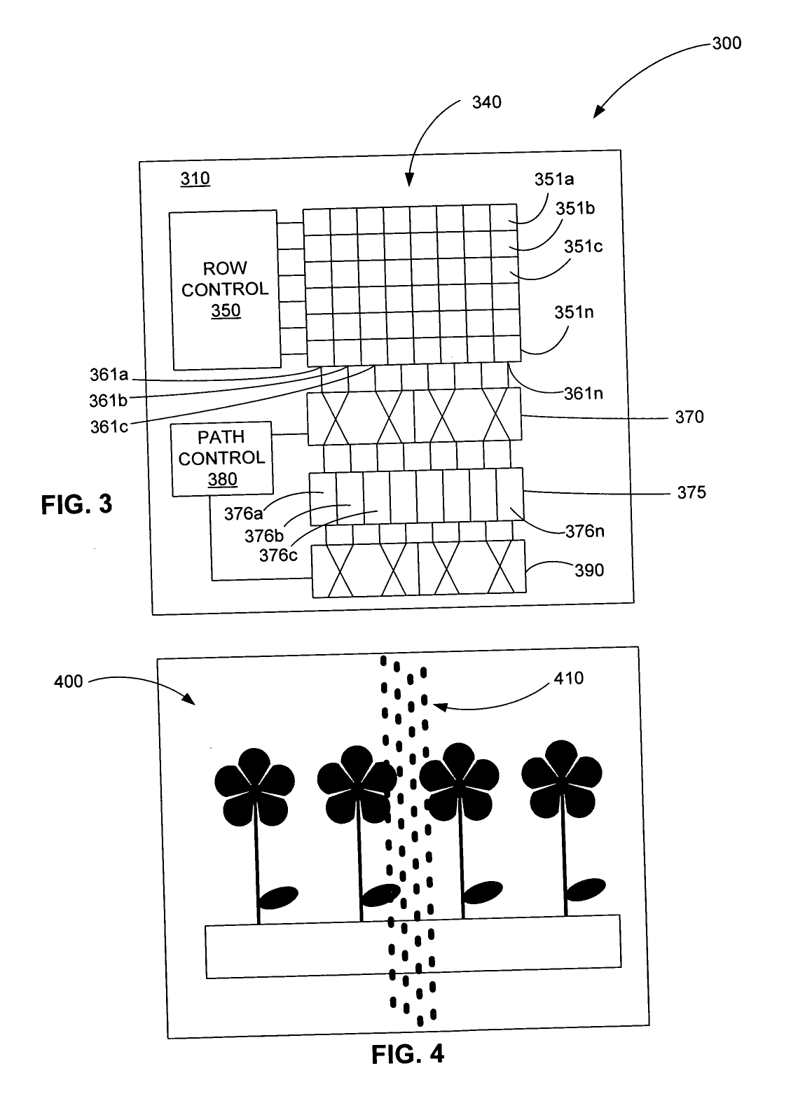

FIG. 3 shows a portion of an imaging system 300 for collecting and storing incident light using a pixel array 340 according to an embodiment of the invention. In this embodiment, the readout path for each pixel is manipulated from row to row through readout path circuitry 370. The system 300 includes a pixel array 340 that, for the purposes of this embodiment, may be a CMOS array. Those skilled in the art will appreciate that any pixel array, such as a CCD array, may also be used. By convention, the pixel array 340 is typically organized into rows 351a-351n and columns 361a-361n such that row control circuitry 350 may be used to manipulate the pixels on a row-by-row basis and column readout circuitry 375 may be used to sample the pixels in a column-by-column basis.

It will also be understood by a person skilled in the art that the row and column control may be the opposite as the control circuitry 350 and 375 need not necessarily be associated with rows and columns. Rather, the references and concepts used herein may simply refer to a group selection circuit (row control circuitry 350) and a pixel selection circuit (column readout circuitry 375). Throughout the remainder of this disclosure, however, row control circuit 350 and column control circuit 375 are used to reference these components.

In a typical image capturing procedure, light striking the pixel array 340 may induce, at each pixel, a charge corresponding to the level of incident light when exposed to light, such as for example, when a shutter opens and closes quickly in a camera. The induced charge at each pixel represents the image that was briefly incident upon the pixel array 340. The imaging system 300 may then readout the charge at each pixel by way of a generated voltage signal corresponding to the level of charge induced. The voltage signal may then be measured and assigned a digital value to be stored in a memory.

During a readout phase of an image-capturing procedure, each pixel in the pixel array 340 may be sampled such that the corresponding voltage signal may be individually measured for magnitude. Thus, the row control circuitry 350 (group selection) isolates an entire row (group) of pixels for readout by initiating a voltage-high signal on a row control line that turns on a row transistor (not shown in detail) at each pixel. Then, each pixel in the enabled row is sampled to determine its stored voltage signal when a column line is initiated with a voltage-high signal (which turns on a column transistor, also not shown in detail) from the column readout circuitry 375. Thus, each column 361a-361n may be sampled, column by column according to a clocked sequence and each voltage signal at each signal in the activated row may be readout. This process repeats for each row until the each pixel in the pixel array 340 has been readout and the image is stored in memory (not shown).

As described in the background section above, each pixel in each column 361a-361n may be associated with readout circuits 375a-375n. Different from prior art, however, the particular readout path that each column follows from row-to-row may change. In this embodiment, a readout path selection circuit 370 is coupled between the column readout circuitry 375 and each column 361a-361n of the pixel array 340. The readout path selection circuit 370 is controlled by a readout path control circuit 380 such that individual columns 361a-361n may be associated (i.e., electrically coupled via readout path selection circuit 370) with different readout circuits 375a-375n.

Thus, the particular readout path for any given column of pixels 361a-361n may be randomized or systematically interchanged between column readout circuits 375a-375n. That is, the pattern by which pixels in a given row are readout may shuffle from row to row. If one particular readout circuit 375a-375n is error-prone, the column 361a-361n that is read through the error-prone readout circuit will be different from row to row. The resulting noise due to the faulty readout path is then distributed across several image columns in the resulting stored image. In order to store an image in its proper format, a readout path reassembly circuit 390, which is also controlled by the readout path control circuit 380, redistributes the column signals back to their original order. That is, the readout path reassembly circuit 390 unshuffles the already readout pixel signals for eventual storage in memory (not shown) via a multiplexer (also not shown).

For example, during a readout phase, the first row 351a may be readout according to a first row pattern. Thus, the pixel in the first column 361a of the first row 351a may be readout through a first readout path 375a, the pixel in the second column 361b of the first row 351a may be readout through a second readout path 375b, the pixel in the third column 361c of the first row 351a may be readout through a third readout path 375c, etc. Then, after the first row is readout, the second row 351b may similarly readout, but with a different readout pattern. Thus, in the second row 351b readout, the pixel in the first column 361a of the second row 351b may be readout through a second readout path 375b, the pixel in the second column 361b of the second row 351b may be readout through a third readout path 375c, the pixel in the third column 361c of the second row 351b may be readout through a fourth readout path (not shown in detail), etc. The remaining rows 351c-351n may also be similarly readout in a random manner or predetermined pattern.

In this manner, if one of the readout circuits 375a-375n is error prone, say for example, the second readout circuit 375b, then the resulting noise from the error prone readout circuit 375b will be distributed among different pixel signals from different columns 361a-361n. In the example above, the first row 351a will have noise (from the error-prone readout circuit 375b) in the pixel in the second column 361b, but the second row 351b will have noise on the pixel signal from the third column 361c, and so on. The effect of randomizing or systematically changing the readout path may be more readily seen in the resulting image of FIG. 4.

FIG. 4 shows a digital picture 400 constructed form data collected by the imaging system 300 of FIG. 3 having a systematically distributed readout path over four columns according to an embodiment of the invention. As can be seen the noise associated with one particular readout path is spread out such that the noise is less noticeable than the picture of FIG. 2. Of course, the effect of the noise is shown in greater detail in FIG. 2 than normal for the purpose of illustration. Typically, a single pixel, when dealing with millions of pixels is not discernable to the human eye.

The embodiment described with respect to FIGS. 3 and 4 utilizes groupings of four columns to distribute readout paths. That is, all of the columns 361a-361n, which may number in the range of 1000 to 100,000, may be divided up into groups or subsets of four columns each, such that each subset is associated with four associated readout circuits as well. Thus, within each subset of columns, the particular readout path may be one of the four readout circuits associated with the column grouping. The pattern for distributing the column readout path among the subsets of four may be truly random as designated by a randomizer (not shown) within the readout path control circuit 380. Then, from row to row, each particular column within each subset may be readout from one of the four associated readout paths such that each of the four columns is uniquely readout through a dedicated readout circuit. For example, in each subset of four columns, (aptly named columns 1, 2, 3, and 4) and first row readout path random pattern may be readout circuits 3, 2, 1, 4, a second row readout path random pattern may be 1, 3, 2, 4, a third readout path pattern may be 4, 3, 2, 1, etc. Thus, the associated readout circuit for each column in the group of four may be, in a random manner, any one of four readout circuits.

Alternatively, the readout path control circuit 380 may provide a specified, predetermined pattern (i.e., not random) for each grouping of columns for each row. Thus, in a first row, the pattern for columns numbered 1, 2, 3, 4, may be readout paths 1, 2, 3, 4. In the next row, the readout pattern may shift to be 2, 3, 4, 1 and the next row may shift again to be 3, 4, 1, 2, etc. In this manner, any noise associated with an error prone column may also be distributed in what appears to the human eye as a random pattern, but is systematically interchanged between readout paths according to a predefined pattern stored in the readout path control circuit.

Whatever readout path pattern is used in the imaging system 300 of FIG. 3 is also used to reconstruct the image is a memory when stored. The readout path control circuit 380 is not only coupled to the readout path circuit 370, but also to the readout path reassembly circuit 390. As such, the pattern designated by the readout path control circuit 380 for the readout path circuit 370 to determine which readout path a particular column signal propagates through is also used to set the readout path reassembly circuit 390 to the proper readout path for the given row of pixels. For example, the readout path control circuit may provide a pattern of 1, 4, 3, 2 for each subset of four columns to the readout path circuit 370. Then, this pattern is also provided to the readout path reassembly circuit 390 in order to read from each subset in the same pattern, 1, 4, 3, 2 so that the resulting data is stored in its proper context.

The embodiments of FIGS. 3 and 4 have been described having columns designated into subsets of four for readout path distribution. In other embodiments, columns may be designated in subsets of 8 or 16. In the same manner as described above, the readout paths may be randomly or systematically distributed across the subsets of 8 or 16 columns as well. Furthermore, the subsets may be any number of columns, even including a single grouping of all columns. Although, the circuitry associated with larger groupings of columns may be too complicated to realize in applications having limited space.

In yet another embodiment, each column readout path may be shifted by one or two for each row. For example, the first column in the first row may be read through a first readout path, the second column in the second row may be readout on a second readout path (or the third readout path if shifting by two) the third column in the third row may be readout by a third readout path (or fifth of shifting by two), etc. Shifting readouts paths by one or two columns may be controlled by the readout path control circuitry 380 much on the same manner as a random path distribution or a predetermined pattern distribution.

In yet another embodiment, a second layer of readout path distribution may be realized. In this embodiment, each column may be associated with a subset of four columns, as well as four readout paths, as described above. Further, a second readout path circuit (not shown) may provide a second readout path distribution for each subset of columns in a second tier of path distribution. Thus, an error prone readout path may be spread out across one of four first level columns and the one of an additional four subsets of columns. The result of a two-tier readout path distribution is an image having even less-noticeable noise due to readout path errors. Again, any number of columns and subsets of columns may be realized. Further, any number of stages may be realized to achieve a more random looking pattern of distribution.

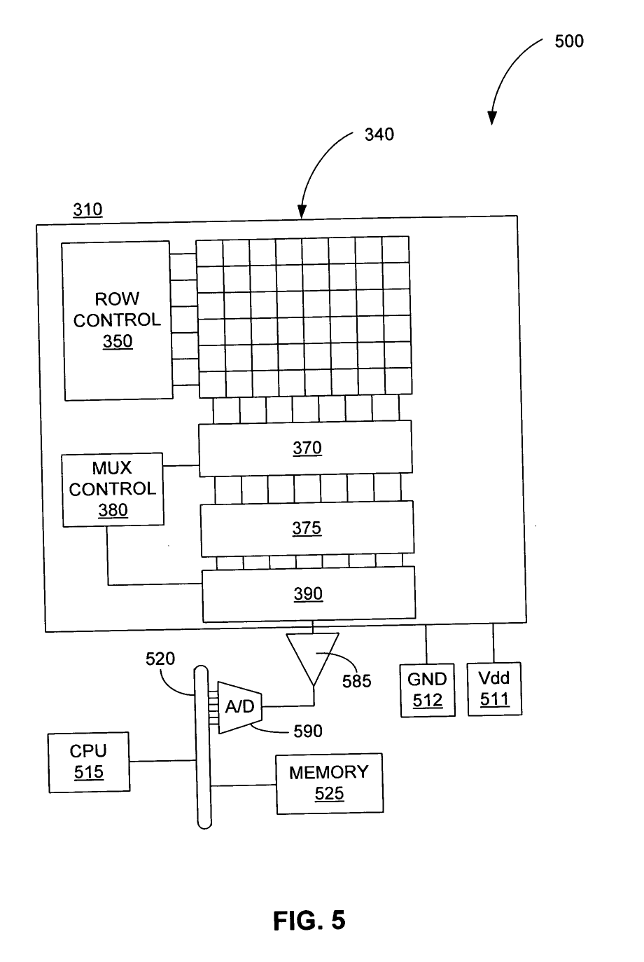

FIG. 5 shows a block diagram of an imaging system 500 that includes the imaging device 300 of FIG. 3 according to an embodiment of the invention. The system 500 may be a digital camera, digital camera-phone, or other electronic device utilizing a digital image-capturing apparatus. Such an apparatus may be of any size and number of pixels each containing a respective photodiode or other light-sensing device. The imaging system 500 is able to integrate a number of processing and control functions, which lie beyond the primary task of photon collection, directly onto a single shell case package. These features generally include timing logic, exposure control, analog-to-digital conversion, shuttering, white balance, gain adjustment, and initial image processing algorithms.

One popular pixel array 340 is built around active pixel sensor (APS) technology in which both the photodiode (not shown) and a readout amplifier (also not shown) are incorporated into each pixel. This enables the charge accumulated by the photodiode to be converted into an amplified voltage signal inside the pixel and then transferred in sequential rows and columns to the analog signal-processing portion of the chip.

Thus, each pixel contains, in addition to a photodiode, a triad of transistors that converts accumulated electron charge to a measurable voltage, resets the photodiode, and transfers the voltage to a vertical column bus. The resulting array 340 is an organized checkerboard of metallic readout busses that contain a photodiode and associated signal preparation circuitry at each intersection, i.e., each pixel. The busses apply timing signals to the photodiodes and return readout information back to the analog decoding and processing circuitry housed away from the array 340. This design enables signals from each pixel in the array 340 to be read with simple x, y addressing techniques.

Pixels are typically organized in an orthogonal grid that may range in size from 128×128 pixels (16 K pixels) to a more common 1280×1024 (over a million pixels). Several of the latest arrays 340, such as those designed for high-definition television (HDTV), contain several million pixels organized into very large arrays of over 2000 square pixels. The signals from all of the pixels composing each row and each column of the array must be accurately detected and measured (read out) in order to assemble an image from the pixel charge accumulation data. Other applications for pixel arrays 340 and subsequently, the entire imaging system 500 of FIG. 5 include a handheld digital cameras, mobile-phone cameras, personal data assistant camera systems, and personal computer camera systems.

The system of FIG. 5 includes a central processing unit (CPU) 515 coupled with a bus 520. Also coupled with the bus 520 is a memory 525 for storing digital images captured by the pixel array 340. The CPU 515 facilitates an image capture by controlling the pixel array 340 through the bus 525 and, once an image is captured, storing of the image in a digital format in the memory 525.

The imaging system 500 includes several components for facilitating the capture and digitization of an image as described above with respect to FIG. 3 and that which is well-known in the art with respect to image capture electronics. Each pixel in the array 340 is coupled to row control circuitry 350 and to column readout circuitry 375 via readout path circuitry 370 as controlled by a readout path selection circuit 380. The readout path may then be unshuffled via the readout path reassembly circuitry 390 and eventually passed to a multiplexer 585. In an alternative embodiment, the readout path reassembly circuitry 390 and the multiplexer 585 may be the one component handling both tasks. Collectively, these components facilitate the control signals for capturing an image as described above. Further, each pixel in the CMOS array 240 is typically coupled to Vdd 511 and GROUND 512 (individual connection not shown).

During a typical image capture procedure, the voltage signal for each pixel is read by the column readout circuitry 375 via a specific pattern determined by the readout path circuit 370 for the readout path control circuit 380 and the readout path reassembly circuitry 390 and sent to a multiplexer 585. The multiplexer 585 combines each voltage signal into a single multiplexed signal which represents the voltage signal captured at each pixel. After an amplification stage (not shown), this signal is converted into a digital signal via an analog-to-digital converter 590 before being communicated to the bus 520. The CPU 515 then facilitates the storage in the memory 525 of the multiplexed digital signal

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

I claim:

1. An imaging device comprising:
a pixel array organized into a plurality of sets of pixels, each pixel in each set of pixels operable to store a signal corresponding to a respective light level;
a readout circuit having a plurality of readout paths coupled to the pixel array, each readout path operable to read the signal stored in a corresponding pixel in a set of pixels, each readout path corresponding to one pixel during a readout phase for each set of pixels; and
a readout path selection circuit coupled to the readout circuit and operable set a pattern for matching one readout path to one pixel for each set of pixels for each readout phase, the pattern differing from set to set.

2. The imaging device of claim 1 wherein each set of pixels corresponds to a row of pixels and each pixel in each row of pixels is readout through a readout path corresponding to a column of pixels.

3. The imaging device of claim 1, further comprising a set control circuit coupled to the pixel array and operable to control which set of pixels among the plurality of sets of pixels is being readout.

4. The imaging device of claim 1 wherein the pixel array comprises one of the group including: a complimentary metal-oxide semiconductor array and a charge-coupled device array.

5. The imaging device of claim 1 wherein the readout path selection circuit further comprises a randomizer operable to provide random numbers that correspond to the patterns for readout paths for each respective set of pixels.

6. The imaging device of claim 1 wherein the readout path selection circuit further comprises a pattern generator operable to provide predetermined patterns of numbers that correspond the patterns for readout paths for each respective set of pixels.

7. The imaging device of claim 1, further comprising a multiplexer operable to:
receive a signal from each readout path;
receive a pattern signal from the readout path selection circuit;
interpret the pattern signal such that each readout path is read in a pattern corresponding to the original order of pixels in each set of pixels; and
generate a multiplexed signal corresponding to stored values in the pixel array.

8. The imaging device of claim 1, wherein each set of pixels is further subdivided into subsets of pixels, each subset of pixels corresponding to a subset of readout paths such that the readout path selection circuit sets patterns corresponding to each subset of pixels.

9. The imaging device of claim 8, wherein each subset of pixels comprises a number of pixels selected form the group comprising: 4, 8, and 16 pixels.

10. The imaging device of claim 1, further comprising a second a readout path selection circuit coupled to the first readout selection circuit and operable set a pattern for matching a set of first readout paths to one second readout path for each readout phase, the pattern differing from set to set.

11. An image-capturing system comprising:
a processing unit operable to control components of the image-capturing system via a system bus;
an integrated circuit coupled to the system bus, the integrated circuit comprising:
a pixel array organized into a plurality of sets of pixels, each pixel in each set of pixels operable to store a signal corresponding to a respective light level;
a readout circuit having a plurality of readout paths coupled to the pixel array, each readout path operable to read the signal stored in a corresponding pixel in a set of pixels, each readout path corresponding to one pixel during a readout phase for each set of pixels;
a readout path selection circuit coupled to the readout circuit and operable set a pattern for matching one readout path to one pixel for each set of pixels for each readout phase, the pattern differing from set to set; and
a multiplexer operable to generate a multiplexed signal corresponding to the store signals in the pixels; and
a memory device coupled to the bus and operable to store the multiplexed signal.

12. The image-capturing system of claim 11, further comprising a digital-to-analog converter coupled between the multiplexer and the system bus.

13. The image-capturing system of claim 11 disposed in one of the group comprising: a handheld digital camera, a mobile-phone camera, a personal data assistant camera system, and a personal computer camera system.

14. A method comprising:
collecting image data in a pixel array, the pixel array organized into a plurality of sets of pixels;
reading a signal stored in each pixel in each set of pixels, each pixel read through a respective readout circuit path in a readout circuit coupled to the pixel array according to a readout pattern for each set; and
differing the readout pattern for each set of pixels.

15. The method of claim 14, further comprising randomizing the readout pattern from set to set.

16. The method of claim 14, further comprising differing the readout pattern from set to set according to a predetermined set readout pattern.

17. The method of claim 14, further comprising multiplexing the read signal into an image data stream and storing the image data stream in a memory.

18. The method of claim 14 wherein reading a signal stored in each pixel, further comprises reading signals from pixels further subdivided into subsets of pixels, each subset of pixels corresponding to a subset of readout paths such that the readout path selection circuit sets patterns corresponding to each subset of pixels.

19. The method of claim 14, further comprising subdividing subsets of pixels into sets of four.

20. The method of claim 14, further comprising:
grouping sets of readout paths for a second-tier readout path circuit;
reading signals passing through each group of readout paths, each path read through a respective second-tier readout circuit path in a second-tier readout circuit coupled to the readout circuit according to a second-tier readout pattern for each group of paths; and
differing the second-tier readout pattern for group of readout paths.
